(19) United States
(12) Patent Application Publication
(10) Pub. No.: US 2010/0303593 A1
(43) Pub. Date: Dec. 2, 2010

(54) Adjustable lift dolly which is used in connection with stand-mounted equipment, power tools and similer items

(76) Inventor: William Donald Peacock, Fleming Island, FL (US)

Correspondence Address: WILLIAM DONALD PEACOCK, 1127 FISHERMANS WAY, FLEMING ISLAND, FL, 32003, US

(21) Appl. No.: 12/454,871

(22) Filed: May 26, 2009

(51) Int. Cl. B60P 1/64

(52) U.S. Cl. 414/458

(57) ABSTRACT

An adjustable lift dolly assembly system is provided for the lifting and transporting, for the purpose of relocation within a given work shop, tool stands and the like, without the associated cumbersome, complicated and costly designs current available. This dolly system consists of two simple, but effective sub-assemblies, one each attached to the side legs of a work shop tool stand and then actuated by stepping on a lifting pedal on each sub-assembly, rising and securely locking the tool stand to a position suitable for relocation within a given work space. Once relocated or moved, a simple step on the trailing edge of the lifting pedals releases the stand to be lowered, by gravity, back to a suitable working position.

### RELATED U.S. APPLICATION DATA

This application claims the rights and benefits of Provisional Patent Application No. 60/130,611, filed on Jun. 2, 2008.

### BACKGROUND OF THE INVENTION

(1) Field of Invention

Various problems and difficulties are encountered when providing a suitable method of relocating a multitude of differently sized stand-mounted power tools such as router tables, sanding tables, table saws, lathes both metal and wood etc. For the proper operation, efficiency and especially personal safety, work shop tool stand must always set firmly on the floor. The ability to readily relocate these types of work shop tool stands from a stored position out to a suitable working space has been and still is an ongoing unresolved problem. To easily move these power tools from storage to a usable work space is highly desirable and in a small workshop, absolutely essential. The embodiment presented in this application solves many of the problems encountered with size-restricted four-sided lift platforms and complicated bar arrangements and locking systems. This embodiment addresses these and other short-comings with an invention of an adjustable, simple, uncomplicated, easily fabricated, easily installed and safe, adjustable lift dolly assembly that will adjust to fit nearly every work shop tool stands on the market today.

(2) Description of Related Art

Several types of transporting devices and dolly mechanisms are presently in use today, with a couple presented and illustrated in U.S. Pat. No. 6,109,625, Hewitt, Aug. 29, 2000 and U.S. Pat. No. 6,715,979, Theising, April 2004. Each took a different approach to lift and relocate a work shop tool stand and will be incorporated in part by reference herein.

In one case, the Universal Mobile Base made by Delta International Machinery Corporation functions sufficiently to accomplish the job of moving a work shop tool stand, but has chosen to use a four-sided platform that has exposed trip surfaces outside the footprint of the stand that could very easily constitute a safety hazard. Using the four-sided platform approach has totally eliminated the possible use of the space between the outer legs for such as cleaning, storage or operations. Another problem with this type embodiment is with the use of wooden side rails (2″×2″) to provide for extending to the desired width as to accommodate variously sized stands. These rails are not an integral part of the system and must be fabricated from wood and cut to size and fitted by the end user. These wooden rails are fragile, are subject to fractures, rot, warping and could present a hazard to the operator.

When considering the purchase of a mobile base for a power tool stand, you have to consider its' cost. If the cost of the mobile base exceeds the cost of the stand it is mounted on, then one might want to consider other alternatives.

The cost of the Universal Mobile Base is reflective of the amount of metal fabrication, welding and associated labor. The embodiment presented in this application consists of only three (3) moving parts per sub-assembly (casters not included); of which two (2) are made from inexpensive and strong 1″×1″ angle iron. There is only one small spot-weld needed on of each assembly.

The Port-a-Mate produced by HTC Products, Inc., while readily doing the task it was designed for, has some of the same drawbacks as the Universal Mobile Base produced by Delta. The four-sided, enclosed platform configuration that the Port-a Mate and Universal Mobile Base are designed around totally defeats the possible use of the space between the stand legs for any purpose what-so-ever. The necessity to add extra metal extensions or fabricated wooden extenders simply adds to the cost and the frustration that the end user has to bear. The fact that in both cases cited above with the four-sided platform design, there are protrusions that stick out beyond the stand footprint around the base. The protrusions (casters and locking systems) present a possible accident and a potential trip hazard.

The Adjustable Lift Dolly, commonly known as the Herculift Lift Dolly that is produced by Ridge Tool Company is unique and may work very well with a standard sized, preferably square or close to square work stand, as is illustrated in prior art of their embodiment. It is unbelievably complicated to install on any work shop tool stand. It is also very difficult to understand how this particular lift dolly art could ever be adjusted enough to fit a five foot (5′) wide lathe or wide work shop tool stand and still function as designed. This lift dolly embodiment is basically limited in its ability to fit a wide variety of stands and is best suited for a near equal sided work stand of from 24″ to 32″, such as a table saw.

With the Herculift art, the problem again presents itself with limiting of the use and access of the underside of the tool work stand for cleaning, storage or other purposes. The use of multiple metal square bars, numerous nuts and bolts, and many other fabricated plastic/rubber and metal parts that are required can only add up to a more expensive product. The cost per lift dolly assembly, by far exceeds the cost of most, if not all market available tool stands.

### SUMMARY AND OBJECTS OF THE INVENTION

After observation of the various arts and embodiments of mobile lift dollies on the market today, it was determined that there had to be a more simple way for a lift dolly to work without the problems created with existing art.

The object of this embodiment was to create an adjustable lift dolly that was:
1. Simple in design and function
2. Inexpensive for the end user to buy
3. Inexpensive and easy to manufacture using as few parts as possible and still accomplish the designed task
4. Easy to assemble and package
5. Easy for the end user to install without additional materials
6. Able to fit most tool stands on the market
7. Simple to operate
8. Free of any protrusions outside the stand footprint
9. Free of any encumbrances between the stand legs or within the operating area
10. Positive locking to ensure safe movement of the tool stand
11. Free of maintenance or adjustments once installed
12. Able to safely fit very wide as well as standard sized tool stands
13. Reusable on all future or replacement tool stands
14. Robust enough to carry the load for most, if not all work shop tools (capacity rated 360 lbs)

The embodiment, as illustrated and related in this application amply provides for all of the above features and has virtually none of the prior referenced problems that are so inherent with the current art on the market.

This lift dolly simply functions within the footprint of the side set of tool stand legs and does not protrude outside the stand footprint nor encumbers the area between each end of the stand.

This embodiment lifts the tool stand by the use of two adjustable lift dolly sub-assemblies, each attached to one of the two opposing outside work shop tool stand legs. The adjoined lifting arms, which, when depressed, by stepping on apex of the adjoined lifting arms with the use of the lifting pedal, sets in motion a fulcrum leaver affect on the work shop tool stand legs with the casters acting as the lift point of the fulcrum. The lifting legs are subsequently and safely locked into a lifted position and the tool stand is prepared for relocation. The lifting arms remain safely locked until such time as the trailing edge of the Lifting Pedal is depressed; releasing the lifting arms and allowing the tool stand to be lowered to the designed operating position, which is firmly resting on the floor.

### BRIEF DESCRIPTION OF THE DRAWINGS

FIG. 1: Shows the embodiment of the present invention attached to a work shop tool stand that is resting firmly on the floor and ready for normal operations. The embodiment is currently in the unlocked position with the casters retracted and the legs of the stand resting firmly on its leveling pads.

FIG. 2: Shows the same embodiment of the present invention attached to a stand-mounted tool but with the lifting arms lowered into the locked position, the casters are engaged, the stand is lifted and supported, ready for relocation.

FIG. 3: Shows an isometric view of the embodiment of the present invention attached to a wide tool stand with the lifting arms lowered into the locked position, the casters are engaged and the stand is lifted, supported and ready for relocation. This view reveals that there are no restrictions in between the outside legs of the stand and there are no protrusions on either side of the stand to possibly cause a trip or safety hazard.

FIG. 4: Shows an isometric blown up view of the Locking Pedal Assembly, Item (L) and its associated method of locking. This view is provided for clarity on the method used to lock the lifting legs together to support the tool stand in a raised position ready for relocation.

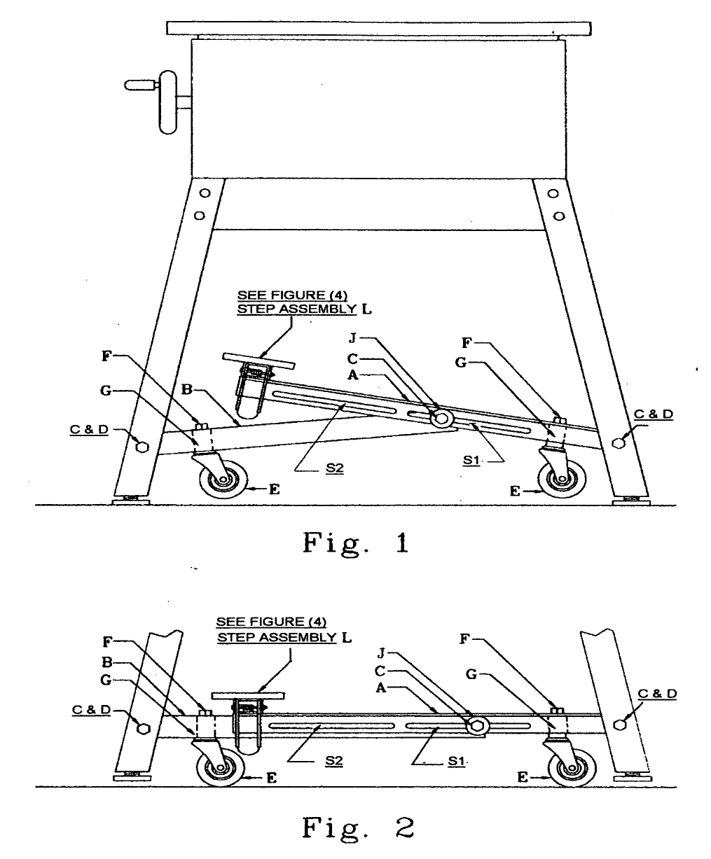

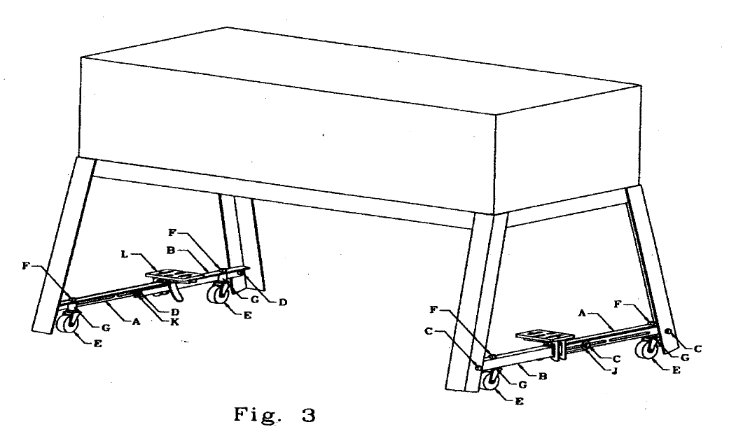

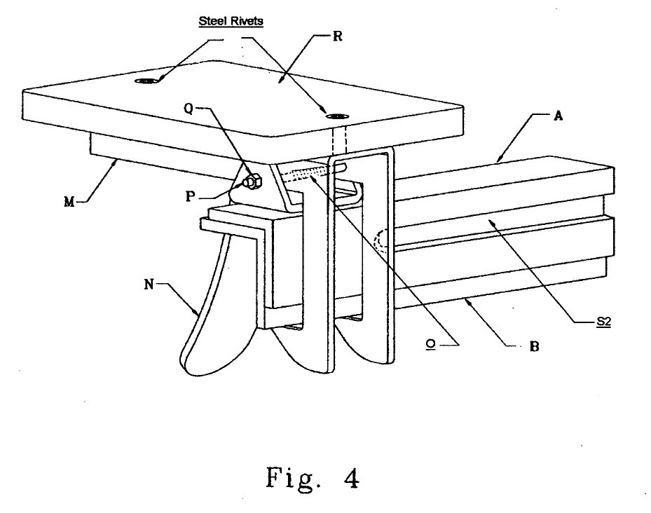

Installation of the embodiment in this application has been simplified and designed toward ease of attachment as a focal point. With the drilling of a single ⅜″ hole that is ½″ in from the interior edge of each leg, and 2¼″ off the floor and with the use of four (4) ⅜″×1″ bolts and locknuts the installation is complete.

While the embodiment of the invention is susceptible to various alternative forms and modifications, specific embodiments have been presented by way of example in the figured drawings and will be detailed herein. It should not be understood that this embodiment is limited to the specific type of tool stand presented. This embodiment is not limited to lifting only tools or tool stands but may be used to move any number of objects other than those disclosed.

### DETAILED DESCRIPTION OF THE INVENTION

The embodiment of this invention directly relates to an adjustable lifting and transporting system that can be used to lift and move various sized work shop tool stands within a given workspace.

In referring to Figure (1), the drawing clearly shows Lift Arm, Item (A) and Lift Arm, Item (B) with associated Locking Pedal Assembly, Item (L) (Later detailed in FIG. (4). Lift Arm, Item (A) is adjoined with a Machine Bolt, Item (C) and large Washer, Item (J); through a Variable Adjustment Slot, Item (Si); then through an elongated hole in Lift Arm, Item (B) and secured with a small Washer, Item (K) and Plastic Insert Locknut, Item (D) (The Variable Adjustment Slot, Item (S1) is designated for all stands with the side leg widths from 18″ to 24″. The Variable Adjustment Slot, Item (S2) is designed to fit stands with the side legs from 25″to 30″). The function of the two manufactured longitudinal cuts in Lift Arm, Item (A), Slots, Items (S1) and (S2) is to allow Lift Arm, Item (B) to self-adjust to variations in spacing of different widths of tool stands legs. Lift Arm, Item (B) would be attached to Slot, Item (S1) for stand end legs widths of from 18″ to 24″ and all measurements in between. Lift Arm, Item (B) would be attached to Slot, Item (S2) for any stand end legs with a width of from 25″ to 30″ and all variations in between.

The 2″ Threaded Casters (4), Items (E) are attached to Lift Arms, Items (A) and (B) through predrilled holes and secured with a Barrel Bushing, Item (G) and Locknut, Item (F).

FIG. (1) further shows the Lift Arms, Items (A) and (B) as being permanently or semi-permanently attached to the tool stand with the use of Machine Bolts, Item (C) and Locknuts, Item (D).

In referring to FIG. (2), Lift Arms, Items (A) and (B) are seen in their locked position, the work shop tool stand legs elevated and ready for relocation.

In referring to FIG. (3), the isometric drawing of a wide stance type work shop tool stand with the embodiment attached; locked in a raised position for moving. This illustration provides a look at how a wide tool stand would look like with a set of adjustable lift dollies attached to each of the opposing ends of the stand.

FIG. (4), refers to the Locking Pedal Assembly, Item (L) and illustrates how a positive lock of Lift Arms, Items (A) and (B) is accomplished. When a downward pressure is applied to the Lifting Pedal, Item (R), which is attached permanently to Lift Arm, Item (A), the arm moves downward, and in doing so, pushes Lift Arm, Item (B) down with it. Lift Arm, Item (B) is guided into position by the Strike Guide and Locking Arm Attachment Plate, Item (N). As Lift Arm, Item (A) proceeds downward from the pressure manually applied to the Lifting Pedal, Item (R), Locking Arm, Item (M) and strikes Lift Arm, Item (B), then rides along its outer surface until it is past the lower edge of the arm and engages by pressure generated by the preloaded Locking Spring, Item (O), forcing Locking Arm, Item (M) under Lift Arm, Item (B). At this point both Lifting Arms, Items (A) and (B) are fully seated and securely locked together. The Locking Arm, Item (M) will remain in the locked position until such time as the Locking Spring, Item (0) is released by the action of manually applying a slight but positive pressure to the trailing edge of the Lifting Pedal, Item (R). After the Locking Arm, Item (M) is disengaged both Lift Arms, Items (A) and (B) are allowed to rise, thereby lowering the work shop tool stand back down to its normal working position.

The Retainer Bolt, Item (P); and Retainer Locknut, Item (Q) are the instruments used to attach the Locking Arm, Item (M) to the Strike Guide and Locking Arm Attachment. Plate, Item (N) and to hold the preloaded Locking Spring, Item (O) in position to control the Locking Arm, Item (M) and are included on this drawing to provide clarity and continuity for the assembly. Lifting Pedal, Item (R) is permanently attached to the Locking Arm, Item (M) with the use of Steel Pop Rivets.

This table lists various descriptive names, quantities required and the associated letter used herein and in the drawings attached hereto.

| ITEM | DESCRIPTIVE NAME | QUANITY INVOLVED |
|---|---|---|
| A | LIFT ARM | 2 |
| B | LIFT ARM | 2 |
| C | MACHINE BOLT 1″ × ⅜″ | 6 |
| D | PLASTIC INSERT LOCKNUT ⅜″ | 6 |
| E | 2″ THREADED CASTER | 4 |
| F | PLASTIC INSERT LOCKNUT ½″ | 4 |
| G | BARREL BUSHING | 4 |
| J | WASHER (Large) | 2 |
| K | WASHER (Small) | 2 |
| L | LOCKING PEDAL ASSEMBLY | 2 |
| M | LOCKING ARM | 2 |
| N | STRIKE GUIDE/LOCKING ARM | 2 |
| | ATTACHMENT PLATE | |
| O | LOCKING SPRING | 2 |
| P | RETAINER BOLT | 2 |
| Q | RETAINER LOCKNUT | 2 |
| R | LIFTING PEDAL | 2 |

1. An adjustable lift dolly assembly support system, that consists of two identical, but separately applied, adjustable lift dolly sub-assemblies that when teamed, in tandem, by having a single said sub-assemblies attached to the inside leading edge of each set of outside support legs of a work shop tool stand or other similar device, provides a viable method for the lifting, moving or the relocation of a said work shop tool stand.

2. A single adjustable lift dolly sub-assembly as one part of a two part adjustable lift dolly assembly, as is set forth in claim 1, herein described and comprised of:
A frame body composed of two movable angle iron lifting bars, opposed and pivotally connected with each other, said frame lifting bars having two free ends respectively and pivotally attached to the lower inside portions of two support legs of said work shop tool stand, two caster assemblies respectively positioned and attached under said frame lifting bars near the two pivotal points of the inside leading edge of the support legs of the said work shop tool stand, the said rear frame lifting bar having a free end and provided thereon with a lifting pedal, having a locking pedal assembly attached under said lifting pedal:
a frame body of the rear lifting bar of the plural said frame lifting bars, having a provided said lifting pedal thereon, and having a locking pedal assembly attached under the said lifting pedal, able to have a manually operated pedal movement by applied manual pressure on said lifting pedal of said rear frame lifting bar causing it to join with the front said frame lifting bar of the plural said frame lifting bars which having been pivotally connected with the said rear frame lifting bar, is rotated and moved downward until joined in-union with respect to said pivotally plural frame lifting bars, the two said frame lifting bars are joined together and forced to remain in a joined, locked in a co-existing position, by the movement action of the locking arm engaging the bottom edge of the said front pivotally connected frame lifting bar, by the force of the preloaded said locking spring, attached to the said locking arm assembly under said lifting pedal:
The resulting action of the two said opposing frame lifting bars being joined together, causes the movement and engagement of the said caster assemblies, forcing a fulcrum affect on the legs of the said work stand, lifting it off the floor sufficiently high enough to be possibly moved or relocated:
The two said frame lifting bars being forced to remain joined together by action of the said locking arm which is being forced firmly against by the preloaded said locking spring and under the leading edge of the said front frame lifting bar as it is in union with the said rear frame lifting bar and being held in that position until such time the trailing edge of said lifting pedal is depressed, by pressure being manually applied, causing the said locking arm to override the preloaded said locking spring, thereby allowing the two said frame lifting bars to be released from their co-joined position and permitting the engaged said caster assemblies to be disengaged, thereby lowering the stand legs of said work shop stand to their normal work station position, which is firmly on the floor:
A rear frame body lifting bar having two longitudinal slots machined in between the free ends of the said lifting bar, accommodating selective positions for the pivotal connection of the opposed said frame lifting bars:
The said longitudinal slots are designed to allow the connection between the front said lifting bar and the opposing and rear said lifting bar to slide parallel within the limits of said longitudinal slots of said rear lifting bar, allowing the sub-assembly said frame lifting bars opposed and pivotally connected to each other to semi-automatically adjust by free movement to various lengths and combination of lengths.

3. The adjustable lift dolly support system, as addressed in claim 1, consisting of two mobile lift dolly sub-assemblies, as described in detail in claim 2, working in tandem, each assembly being attached to opposing sides of the said work shop tool stand, and working independently of each other, able to provide, with the use of manual power applied to the said pedals of each of the said adjustable lift dolly sub-assemblies, in sufficient force to lift said work shop tool stand to a lifted position, and lock it in that position until such time as manual pressure is applied to each said adjustable lift dolly sub-assembly said pedals, lowering the work shop tool stand to its normal and safe work position.

4. That the adjustable lift dolly assembly system, as described in claim 1, and as detailed in claim 2, consisting of two, identically configured, adjustable lift dolly sub-assemblies, that can be interchangeably attached to either side of the outside set of legs on a work shop tool stand, requiring only a single production model of the sub-assembly to be manufactured to fit either side of the said work shop tool stand.
